(19) United States
(12) Patent Application Publication
(10) Pub. No.: US 2010/0251514 A1
(43) Pub. Date: Oct. 7, 2010

(54) CASTER

(75) Inventors: RANDAL P. GOLDBERG, San Jose, CA (US); DEAN F. HOORNAERT, San Jose, CA (US); DEEPAK R. KAPOOR, Cupertino, CA (US); MARK W. ZIMMER, Fremont, CA (US)

Correspondence Address: PATENT DEPT;INTUITIVE SURGICAL OPERATIONS, INC, 1266 KIFER RD, BUILDING 101, SUNNYVALE, CA, 94086, US

(73) Assignee: Intuitive Surgical, Inc., Sunnyvale, CA (US)

(21) Appl. No.: 12/416,201

(22) Filed: Apr. 1, 2009

(51) Int. Cl. B60B 33/00

(52) U.S. Cl. 16/47

(57) ABSTRACT

A caster assembly includes a primary wheel and a secondary wheel. As the caster assembly is rolled against and over an obstacle threshold, the secondary wheel is positioned to contact the obstacle threshold first. As the caster assembly begins to roll over the threshold, the secondary wheel lifts the caster assembly part way. As the caster assembly continues to roll over the threshold, the primary wheel contacts the threshold and lifts the caster assembly over the obstacle threshold. One or more secondary or primary wheels may be used. The secondary wheel or wheels may be positioned to remain within a sweep volume of the primary wheel as the caster assembly swivels around a caster swivel axis.

### BACKGROUND

1. Field of Invention

Aspects of the invention are related to casters, and more particularly are related to casters that facilitate rolling an object over obstacles.

2. Art

A caster is a small wheel that is attached to the underside of an object to make the object easier to move. A proposed change to International Electrotechnical Commission (IEC) General Standard IEC 60601-1) includes a requirement 9.4.2.4.3 that states that equipment, when moved at a nominal walking speed of 0.4 m/s, must be able to climb over a barrier 20 mm high by 80 mm wide. The ability to climb over a threshold or obstacle such as this is a function of the diameter and material of a caster wheel used to support the equipment object. In some cases, it is no problem for designers to increase the diameter of their casters to be able to meet this requirement. In other cases, however, smaller sized wheels may be desirable or available swept volume for a pivoting caster may be limited.

A twin wheel caster assembly (the “Series 551D”) available from Magnus Mobility Systems, Inc. of Orange, Calif. appears to offer a proposed solution to this problem. A small ramp on the bottom of the caster assembly contacts the top of the obstacle, and the caster assembly slides up the obstacle threshold along the ramp until the caster wheel once again can contact a level rolling surface. A disadvantage to this configuration is that the obstacle threshold must be sufficiently fixed and solid to withstand the pushing force necessary to lift the caster assembly. Another disadvantage to this configuration is that friction between the obstacle and the ramp may prevent the caster from smoothly passing over the obstacle.

What is desired is a caster that can easily climb relatively high obstacles while minimizing caster height. It is further desired that the caster minimize swept volume as it swivels. In addition, it is desired that the caster be able to pass over as many types of obstacles as possible, without requiring the obstacle to be solidly fixed in position.

### SUMMARY

This section is a simplified summary of some aspects and embodiments in order to provide a basic understanding of the invention. This summary is not an extensive overview of the invention. It is not intended to identify key/critical elements of the invention or to delineate the scope of the invention. Its sole purpose is to present some aspects and embodiments of the invention in a simplified form as a prelude to the detailed description below.

A caster assembly includes at least one primary wheel and at least one secondary wheel. The caster assembly normally rolls on the primary wheel(s) as it travels over a surface, such as the floor. The secondary wheel(s) is/are positioned in front of the primary wheels(s), and the secondary wheel(s) is/are positioned to be normally above the surface. When the caster assembly is rolled against the threshold of an object, the secondary wheel(s) contact(s) the object before the primary wheel(s) contact(s) the object. As the caster assembly begins to roll over the object's threshold, the secondary wheel(s) partially lift(s) the caster assembly. As the caster assembly continues to roll over the object's threshold, the primary wheel(s) contact(s) the threshold and lift the caster assembly fully over the threshold.

Various configurations of primary and secondary wheels may be used. In one embodiment, for example, a single primary wheel and two secondary wheels are used, with one secondary wheel positioned on either side of the primary wheel. Wheel tread surfaces may be rounded to assist aligning the caster assembly for crossing a threshold that is not perpendicular to the assembly's direction of travel when it contacts the threshold. An outer surface of the secondary wheels may be continuously curved to further assist with such alignment. In some aspects, the secondary wheel(s) is/are positioned to remain within a sweep volume of the primary wheel(s) as they swivel around a caster swivel axis, which allows the caster assembly to be used in place of a conventional caster assembly with no increase in sweep volume design constraints.

### BRIEF DESCRIPTION OF THE DRAWINGS

FIGS. 1A and 1B are diagrammatic side elevation views that illustrate a caster assembly, and FIG. 1C is a diagrammatic side elevation view of an illustrative use for a caster assembly.

FIGS. 2A and 2B are diagrammatic top views that illustrate further configurations and aspects of a caster assembly.

FIG. 3 is another diagrammatic top view that illustrates another configuration and aspects of a caster assembly.

FIGS. 4A and 4B are more diagrammatic top views that illustrate further configurations and aspects of caster assemblies.

FIG. 5 is yet another diagrammatic top view that illustrates a configuration and aspects of a caster assembly.

FIG. 6A is a side elevation view of a caster assembly, and FIG. 6B is a front elevation view of the caster assembly shown in FIG. 6A.

FIG. 7 is a front elevation view of another caster assembly.

FIG. 8 is a front elevation view of yet another caster assembly.

### DETAILED DESCRIPTION

This description and the accompanying drawings that illustrate aspects and embodiments of the present invention should not be taken as limiting—the claims define the protected invention. Various mechanical, compositional, structural, electrical, and operational changes may be made without departing from the spirit and scope of this description and the claims. In some instances, well-known circuits, structures, or techniques may not have been shown or described in detail in order not to obscure the invention. Like numbers in two or more figures represent the same or similar elements.

Further, this description's terminology is not intended to limit the invention. For example, spatially relative terms—such as “beneath”, “below”, “lower”, “above”, “upper”, “proximal”, “distal”, and the like—may be used to describe one element's or feature's relationship to another element or feature as illustrated in the figures. These spatially relative terms are intended to encompass different positions and orientations of the device in use or operation in addition to the position and orientation shown in the figures. For example, if the device in the figures is turned over, elements described as “below” or “beneath” other elements or features would then be “above” or “over” the other elements or features. Thus, the exemplary term “below” can encompass both positions and orientations of above and below. The device may be otherwise oriented (rotated 90 degrees or at other orientations) and the spatially relative descriptors used herein interpreted accordingly. Likewise, descriptions of movement along and around various axes includes various special device positions and orientations. In addition, the singular forms “a”, “an”, and “the” are intended to include the plural forms as well, unless the context indicates otherwise. And, the terms “comprises”, “comprising”, “includes”, and the like specify the presence of stated features, steps, operations, elements, and/or components but do not preclude the presence or addition of one or more other features, steps, operations, elements, components, and/or groups. Components described as coupled may be electrically or mechanically directly coupled, or they may be indirectly coupled via one or more intermediate components. All examples and illustrative references are non-limiting and should not be used to limit the claims to specific implementations and embodiments described herein and their equivalents. Further, aspects described with reference to one embodiment or implementation are not to be construed as being limited to that aspect or implementation, and it should be understood that aspects described herein may be applied in various combinations to various embodiments and implementations covered by the scope of the claims.

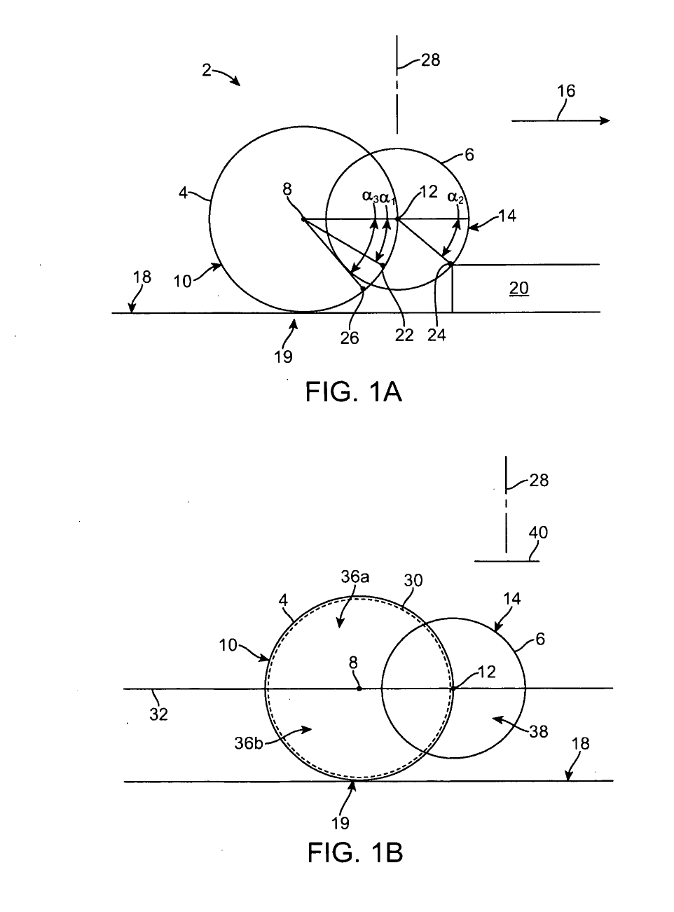

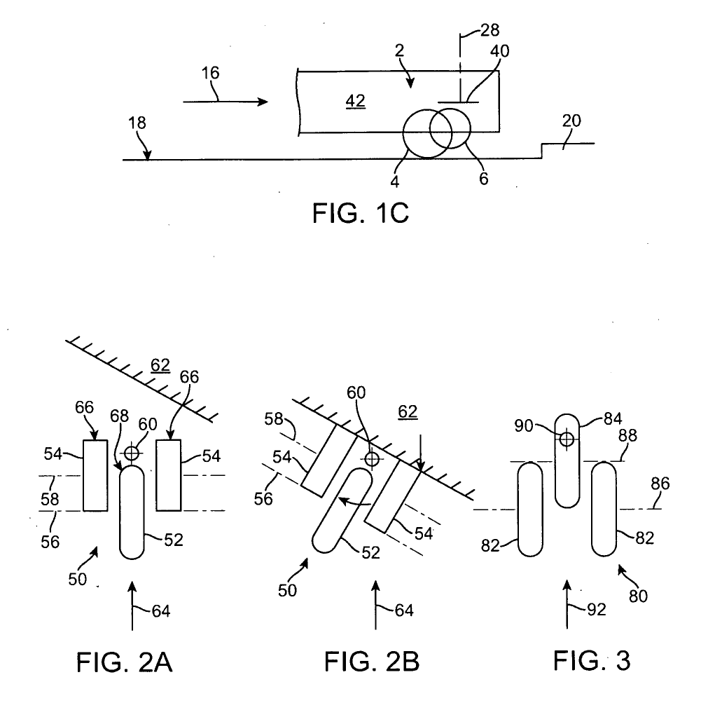

FIGS. 1A and 1B are diagrammatic side elevation views that illustrate a caster assembly in accordance with aspects of the invention. FIG. 1A depicts caster assembly 2, which includes a primary wheel 4 and a secondary wheel 6. Primary wheel 4 rotates around its center axis 8 and has an outer tread surface 10. Likewise, secondary wheel 6 rotates around its center axis 12 and has an outer tread surface 14. For this part of the description, caster assembly 2's operation is illustrated as it moves from left to right in the drawing, as shown by direction arrow 16.

During castering, caster assembly 2 rolls along rolling surface 18 (e.g., a floor). Primary wheel 4's outer tread surface 10 is in contact with rolling surface 18 at contact patch 19. An obstacle 20 lies in caster assembly 2's path as it rolls along surface 18. It can be seen from FIG. 1A that without secondary wheel 6, primary wheel 4 would contact obstacle 20 at position 22 on tread surface 10. Contact at position 22 would result in a contact angle α₁ for primary wheel 4. This contact angle would require a large force in the direction of left-to-right arrow 16 (e.g., provided by an operator pushing an object that the caster assembly supports) to provide the necessary vertical force component to lift the object that the caster assembly supports over the threshold of obstacle 20. That is, primary wheel 4 may bind against the obstacle threshold and be unable to climb over obstacle 20.

In accordance with aspects of the invention, however, secondary wheel 6 contacts object 20 before primary wheel 4. Secondary wheel 6 contacts obstacle 20 at position 24 on tread surface 14, which results in a contact angle α₂ on secondary wheel 6. Contact angle α₂ is larger than contact angle α₁ on primary wheel 4, and so a relatively smaller pushing force is required on caster assembly 2 across rolling surface 18 than if secondary wheel 6 were not so positioned. It can be seen then, that as caster assembly 2 moves towards, up onto, and over obstacle 20, secondary wheel 6 partially lifts caster assembly 2, and consequently the object the caster assembly supports (not shown), over obstacle 20's threshold. As caster assembly 2 continues to move from left to right over obstacle 20, primary wheel 4 then contacts obstacle 20 at position 26 on tread surface 10. Contact at position 26 results in a contact angle α₃. Since contact angle α₃ is larger than contact angle α₁, a relatively smaller pushing force is required on caster assembly to lift main wheel over obstacle 20's threshold than if secondary wheel 6 were not so positioned. These aspects may be implemented with many variations.

In some aspects, caster assembly 2 is a swiveling caster and swivels around caster swivel axis 28 (e.g., with the use of conventional bearings). In swiveling caster embodiments, primary wheel axis 8 is generally offset from caster swivel axis 28, as illustrated in FIG. 1A, so as to provide a positive caster angle (wheel axis 8 is offset behind swivel axis 28) as caster assembly 2 rolls on rolling surface 18. In addition, caster swivel axis 28 is generally perpendicular to rolling surface 18 as shown, but in some aspects may be other than perpendicular.

The position of secondary wheel axis 12 may be varied with reference to primary wheel axis 8. For instance, secondary wheel axis 12 may be closer to or farther from rolling surface 18 than primary wheel axis 12. Further, secondary wheel axis 12 may be aligned with or offset from caster swivel axis 28 so that a positive, zero, or negative caster angle is established as secondary wheel 6 first contacts obstacle 20's threshold. Maintaining caster alignment for zero or negative caster angles is illustrated in more detail below. In general, a positive caster angle for both the primary and secondary wheel promotes stability as the caster assembly contacts and rolls over an obstacle. There is a risk that the caster assembly might rotate and jam against an obstacle if the caster angle for the secondary wheel is negative (offset to the opposite side of the caster swivel axis from the primary wheel caster angle; i.e., in front of the swivel axis as the caster travels).

Finally, the primary and secondary wheels may have various diameters, widths, and tread cross sections, the wheels and treads may be made of various materials and may be of various types. In some instances secondary wheel 6's diameter is smaller than primary wheel 4's diameter, as illustrated in FIG. 1A. In other instances, however, both primary and secondary wheels may have the same diameter. A secondary wheel 6 diameter larger than the primary wheel 4 diameter is within the aspects of the invention. The outer tread rolling surfaces (smooth, grooved, or otherwise patterned) of primary wheel 4 and secondary wheel 6 may be relatively inelastic (e.g., hard plastic, hard rubber, metal, and the like) or relatively elastic (e.g., soft rubber, urethane, and the like). The compressability of the tread of secondary wheel 6 may be a factor in determining secondary wheel axis 12's position, since it affects the effective contact point 24 for various anticipated objects 20 to be crossed. The caster assembly wheels may be standard wheels, or they may be omni-directional (mechanum) or spherical wheels, or combinations thereof.

In one aspect, secondary wheel axis 12 is located, and secondary wheel 6's diameter is sized, so that secondary wheel 6 remains within primary wheel 4's sweep volume as it swivels around caster swivel axis 28. An advantage of this configuration is that an embodiment of the invention can be used when a particular conventional caster wheel diameter has been specified for an object to be supported, and the new caster embodiment will not add to the sweep volume of the conventional caster's wheel and interfere with structures around the originally specified caster.

Referring to FIG. 1B, in general terms it can be seen that the outer tread surface 10 of primary wheel 4 may define the outer surface of an extended cylinder (illustrated by dashed line 30) having a center axis substantially coincident with primary wheel axis 8. A plane (illustrated by line 32) that is parallel to rolling surface 18 and that includes primary wheel axis 8 may also be defined, and this plane bisects the cylinder into upper half 36a and lower half 36b, the lower half 36b being nearest to rolling surface 18. Secondary wheel 6 is then positioned so that at least a portion of its outer tread surface 14 is in the region between rolling surface 18 and defined plane 32, and at least a portion of its outer tread surface 14 is outside of the bottom half of the defined cylinder 30. And, it can be further seen from FIG. 1B that for a caster base 40 that supports primary wheel 4 and secondary wheel 6 (e.g., with a yoke or other suitable mechanical structure; see illustrative embodiments described below), the vertical distance between base 40 and the lowermost outer tread 10 position (i.e., contact patch 19 when caster assembly 2 is in contact with rolling surface 18) is larger than the vertical distance between base 40 and the lowermost outer tread 14 position.

FIG. 1C is a diagrammatic side elevation view of an illustrative use for a caster assembly 2. As shown in FIG. 1C, caster assembly 2 is mounted to support a surgeon's console 42 that is part of a da Vinci® Surgical System manufactured by Intuitive Surgical, Inc. of Sunnyvale, Calif. Surgeon's console 42 is illustrative of various objects on which a caster assembly in accordance with aspects of the invention may be mounted. As shown in FIG. 1C, caster assembly 2 swivels around caster swivel axis 28 as it travels in a direction indicated by arrow 16 that is generally towards an obstacle 20. Obstacle 20 is illustrative of various thresholds that surgeon's console 42 may have to cross, such as elevator floor thresholds, room door thresholds, objects (e.g., power cords) lying on rolling surface 18, and the like. Caster assembly 2 lifts surgeon's console 42 up, onto, and over obstacle 20's threshold as described above. Consequently, caster assembly 2 facilitates compliance with the proposed International Electrotechnical Commission (IEC) General Standard IEC 60601-1 threshold crossing requirements, as referred to above.

FIGS. 2A and 2B are diagrammatic top views that illustrate further configurations and aspects of a caster assembly in accordance with the invention. FIG. 2A shows caster assembly 50 having a single primary wheel 52 and two secondary wheels 54. The secondary wheels 54 are positioned on either side of primary wheel 52. Primary wheel 52 rotates around axis 56, and secondary wheels 54 rotate around axis 58. Caster assembly 50 swivels around caster swivel axis 60. Primary wheel axis 56 is offset from caster swivel axis 60 to provide a positive castor angle for caster assembly 50. Likewise, secondary wheels axis 58 is offset from caster swivel axis 60 to provide a positive caster angle for secondary wheels 54. In some embodiments, however, secondary wheel axis 58 may be aligned with caster swivel axis 60 (zero caster angle) or in front of caster swivel axis 60 (negative caster angle) with respect to primary wheel axis 56, as described above. The position of secondary wheels 54 outside of primary wheel 52 helps to align caster assembly 50 as the caster assembly travels towards an obstacle 62, as indicated by directional arrow 64 (bottom to top, as shown in the drawing).

As caster assembly 50 approaches obstacle 62 in direction of travel 64, both secondary wheels 54 will contact obstacle 62's threshold simultaneously if the threshold is perpendicular to direction of travel 64. As illustrated in FIG. 2B, however, if obstacle 62's threshold is not perpendicular to direction of travel 64, then one of the secondary wheels 54 will contact the threshold first. If the threshold provides sufficient reactive force, such contact will cause caster assembly 50 to pivot around caster swivel axis 60 until both secondary wheels 54 contact the threshold. Then, as caster assembly 50 continues to move, the secondary wheels 54 begin to lift it as described above.

As illustrated in FIGS. 2A and 2B, the secondary wheels 54 have a generally flat cross-sectional contact surface 66. Such a flat surface further helps to align the caster assembly when it contacts non-perpendicular obstacles, as described above. Alternatively, a relatively rounder cross-sectional contact surface may be used, as illustrated by primary wheel contact surface 68. An advantage to using such a rounded contact surface on the primary wheel is that it helps to align the primary wheel to be perpendicular to obstacles that have relatively low threshold heights that do not contact the secondary wheels (e.g., when turning into an obstacle). A rounded contact surface also helps the wheel move over the obstacle by providing a slightly larger initial contact angle when the wheel first contacts a non-perpendicular obstacle threshold.

FIG. 3 is another diagrammatic top view that illustrates another configuration and aspects of a caster assembly in accordance with the invention. Depicted in FIG. 3 is caster assembly 80 having two primary wheels 82 and a single secondary wheel 84. Primary wheels 82 rotate around axis 86 and secondary wheel 84 rotates around axis 88. As shown, both axes 86 and 88 are offset from caster swivel axis 90 to provide a positive caster angle for both the primary and secondary wheels in reference to direction of travel 92. As described above, however, the position of secondary wheel axis 88 in relation to caster swivel axis 90 may be varied. The contact surface 94 of secondary wheel 84 is rounded, which as described above may assist caster assembly 80 to align with and move over obstacles that are not perpendicular to direction of travel 92.

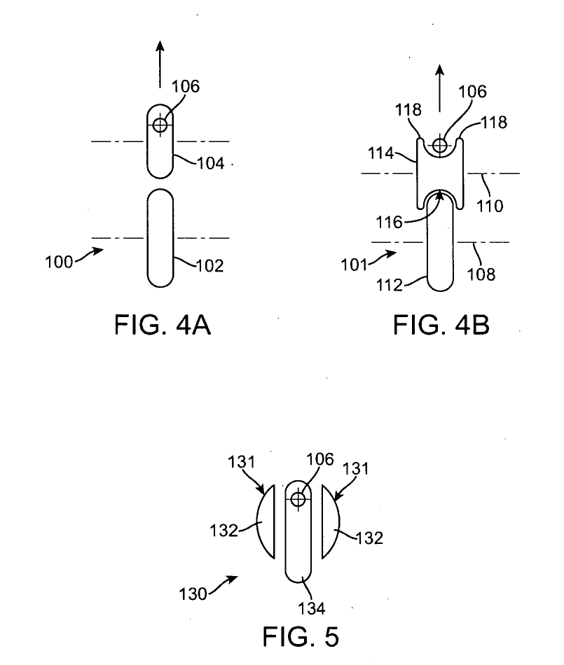

FIGS. 4A and 4B are more diagrammatic top views that illustrate further configurations and aspects of caster assemblies in accordance with aspects of the invention. It can be appreciated that if only a single primary and secondary wheel are used, and if the single secondary wheel is offset from the plane of the main wheel, then the secondary wheel would tend to pivot the caster around the caster swivel axis whenever the secondary wheel contacts an obstacle threshold. Accordingly, if a single primary and single secondary wheel are used, then they are aligned in tandem as illustrated in FIG. 4A. Thus caster assembly 100 shown in FIG. 4A has a single primary wheel 102 and a single secondary wheel 104 aligned in tandem with primary wheel 102 with reference to caster swivel axis 106. The various wheel axis positions, contact surface cross sections, etc. described above apply to the configurations illustrated by FIGS. 4A and 4B.

FIG. 4B depicts a variation 101 of the FIG. 4A tandem configuration. In order to move the primary wheel axis 108 and secondary wheel axis 110 closer together when the primary and secondary wheels are in tandem, the contact surface of primary wheel 112 travels within a groove 116 in the outer tread of secondary wheel 114. Thus secondary wheel 114 has two contact surfaces 118, and the configuration of caster assembly 101 is effectively the same as for the single primary and two secondary wheel configuration illustrated in FIGS. 2A and 2B. It can be seen that in a similar manner, the contact surface of secondary wheel 114 may travel in a groove in the primary wheel's outer tread, thus making this configuration effectively the same as the one illustrated in FIG. 3.

FIG. 5 is yet another diagrammatic top view that illustrates a configuration and aspects of the invention. Caster assembly 130 as shown in FIG. 5 has a single primary and two secondary wheel configuration as illustrated by FIGS. 2A and 2B. As shown in FIG. 5, the outer surfaces 131 of the two secondary wheels 132—the surfaces facing away from primary wheel 134—are continuously curved (e.g., spherical). In a manner similar to the use of a rounded contact surface as described above, this continuous curvature helps align and lift the caster assembly over an obstacle threshold. That is, each of the secondary wheels in one illustrative implementation may be considered to act as part of a spherical wheel.

For all the caster assembly configurations in accordance with the invention, including but not limited to those described herein, it will be appreciated that various yoke configurations may be used to support the one or more primary and secondary wheels. Designing the various yoke configurations is routine in view of this description. Skilled artisans will know of various suitable materials and manufacturing methods.

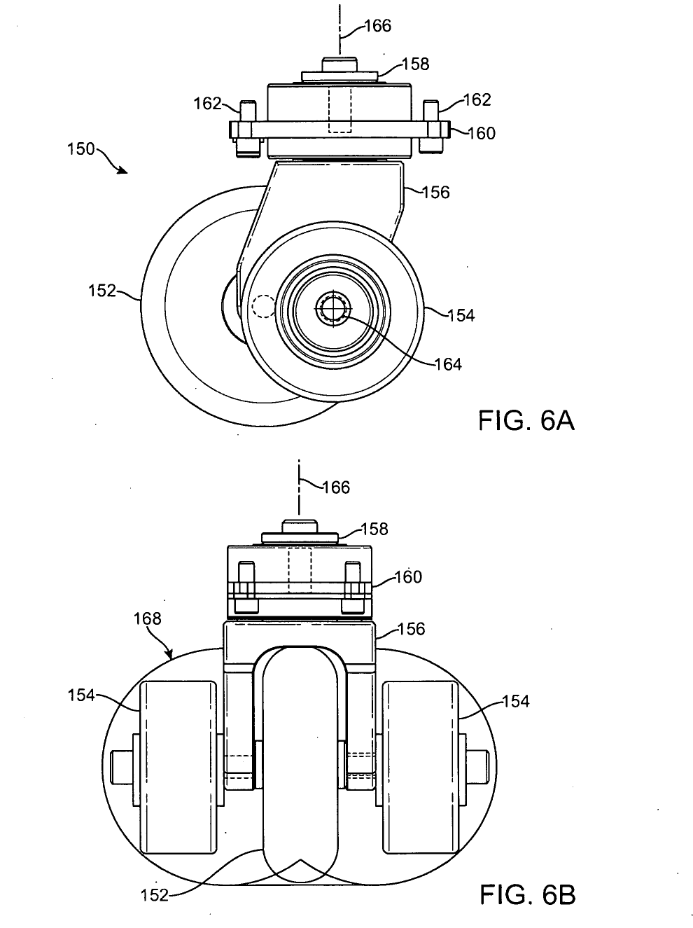

FIG. 6A is a side elevation view of an illustrative embodiment of the invention. As shown in FIG. 6A, caster assembly 150 includes a single primary wheel 152 and two secondary wheels 154, one on each side of primary wheel 152. The primary wheel 152 and secondary wheels 154 are supported by a yoke 156. Yoke 156 is coupled to caster swivel bearing assembly 158, which is held by caster mount bracket 160. In this illustrative embodiment, caster assembly 150 is attached to the object it supports by bolts 162 (two of four total are shown) through mount bracket 160. The center of the secondary wheel axles 164 is slightly offset from the caster swivel axis 166 to provide a positive caster angle to the secondary wheels.

In the depicted embodiment, primary wheel 152 is a 4-inch by 1¼-inch wheel made of 75 durometer urethane. An anti-static additive is used to control static electricity (e.g., for use in a health care environment, such as a surgical operating room). The tread cross section is generally round to help with pivoting (due to a generally symmetric contact patch), to help cross obstacles as described above, and to allow the tread to deform when first contacting an obstacle threshold (to help cushion the impact). Secondary wheels 154 are 3-inch by 1¼-inch “X-tra Soft” square tread rubber wheels made by Albion Inc. of Albion, Mich. Swivel bearing assembly 158 uses conventional tapered roller bearings. The depicted embodiment complies with the proposed IEC 60601-1 20 mm height by 80 mm width barrier crossing requirement referred to above.

FIG. 6B is a front elevation view of caster assembly 150 shown in FIG. 6A. FIG. 6B shows that yoke 156 supports primary wheel 152 with a single axle and secondary wheels 154 with individual axles mounted on each yoke arm.

FIG. 6B also shows that primary wheel 152 and secondary wheels 154 are sized and positioned such that secondary wheels 154 remain within primary wheel 152's sweep volume 168 as it swivels around caster swivel axis 166. Thus the secondary wheels do not require additional sweep volume over that required by the primary wheel, and caster assembly 150 can be used in an application for which a caster having only the primary wheel was specified.

An illustrative use for the caster assembly embodiment 150 depicted in FIGS. 6A and 6B is to support an Intuitive Surgical, Inc. da Vinci® Surgical System surgeon's console, which must be moved from time to time in a surgical operating room environment, and which may encounter various floor obstacles such as elevator door thresholds, sheathed electrical lines, and the like. Four caster assemblies 150 are used, one at each corner of the surgeon's console. For braking, a ring (not shown) is positioned to be generally centered around caster swivel axis 166. The ring is pressed down to contact the primary wheel's tread surface, and friction between the ring and the primary wheel (plus deformation of the tread surface) prevents the primary wheel from rotating.

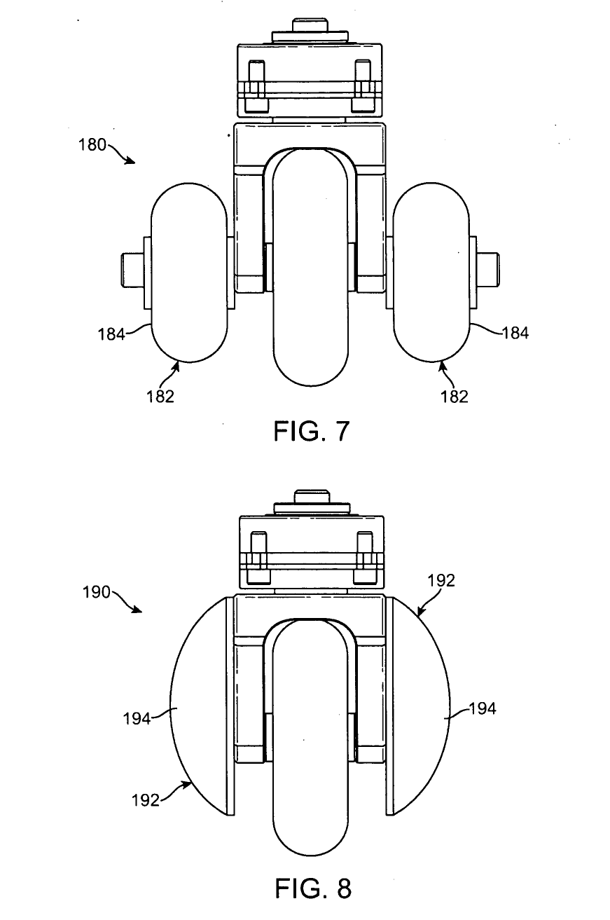

FIG. 7 is a front elevation view of another illustrative caster assembly embodiment 180 in accordance with aspects of the invention. Caster assembly 180 is similar in configuration to caster assembly 150 shown in FIGS. 6A and 6B, and differs by having the contact surface of the secondary wheels be rounded as discussed above.

FIG. 8 is a front elevation view of yet another illustrative caster assembly embodiment 190 in accordance with aspects of the invention. As shown in FIG. 8, the outer surfaces 192 of secondary wheels 194 are continuously curved (e.g., spherical). The caster assembly 190 depicted in FIG. 8 embodies aspects of caster assembly 130 discussed above with reference to FIG. 5.

It can be seen that numerous variations of primary and secondary wheel numbers may be used (e.g., three primary wheels and two outboard secondary wheels; three primary wheels and four secondary wheels-two outboard of and two between the main wheels; four primary wheels and three secondary wheels each between the primary wheels; etc.).

It can also be seen that, if desired, one or more wheels may be mounted in a manner similar to the secondary wheels described herein, but behind the primary wheel. Such wheels function to lessen the restraining force required as the caster assembly crests and rolls over and down a descending obstacle threshold. Accordingly, such tertiary wheels may help to cushion the impact of the caster assembly as the primary wheel is lowered to contact the rolling surface beyond the obstacle.

Having now described various aspects and embodiments of the invention, the following claims are made.

What is claimed is:

1. A caster assembly comprising:
a primary wheel; and
a secondary wheel;
wherein the secondary wheel is positioned to contact an obstacle and lift the primary wheel before the primary wheel contacts the obstacle as the caster assembly casters over the obstacle.

2. The caster assembly of claim 1 further comprising:
a second secondary wheel;
wherein the secondary wheels are positioned one on each side of the primary wheel; and
wherein the secondary wheels are positioned to rotate coaxially.

3. The caster assembly of claim 2 further comprising:
a caster swivel joint that defines a caster swivel axis;
wherein the axis of rotation of the primary wheel and the axis of rotation of the secondary wheel are both offset behind the caster swivel axis as the caster assembly casters over the obstacle.

4. The caster assembly of claim 2 further comprising:
a caster swivel joint that defines a caster swivel axis;
wherein the secondary wheels are positioned to remain within a sweep volume of the primary wheel as the caster assembly swivels around the caster swivel axis.

5. The caster assembly of claim 2:
wherein the secondary wheels have a generally flat tread.

6. The caster assembly of claim 2:
wherein the secondary wheels have a generally rounded tread.

7. The caster assembly of claim 2:
wherein the secondary wheels each have a continuously curved outside surface facing away from the primary wheel.

8. The caster assembly of claim 1 further comprising:
a second primary wheel;
wherein the primary wheels are positioned to rotate coaxially.

9. the caster assembly of claim 1:
wherein the primary and secondary wheels are aligned in tandem.

10. The caster assembly of claim 9:
wherein the tread of the secondary wheel is circumferentially channeled and provides two rolling surfaces; and
wherein the two rolling surfaces are positioned one on each side of the primary wheel.

11. The caster assembly of claim 1 further comprising:
a caster swivel joint that defines a caster swivel axis;
wherein the axis of rotation of the primary wheel and the axis of rotation of the secondary wheel are both offset behind the caster swivel axis as the caster assembly casters over the obstacle.

12. The caster assembly of claim 11:
wherein the secondary wheel is positioned to remain within a sweep volume of the primary wheel as the caster assembly swivels around the caster swivel axis.

13. A caster assembly comprising:
a caster base;
a primary wheel coupled to the caster base; and
a secondary wheel coupled to the caster base;
wherein a vertical distance between the caster base and a lowermost tread position of the primary wheel is larger than a vertical distance between the caster base and a lowermost tread position of the secondary wheel; and
wherein at least a portion of the tread of the secondary wheel is positioned outside a bottom half of a cylinder surface defined by the tread of the primary wheel.

14. The caster assembly of claim 13 further comprising:
a caster swivel joint coupled to the caster base;
wherein the caster swivel joint defines a caster swivel axis around which the caster swivel joint swivels; and
wherein the caster swivel joint is positioned to provide a positive caster angle for the primary and secondary wheels.

15. The caster assembly of claim 14:
wherein the secondary wheel is positioned to remain within a sweep volume of the primary wheel as the caster assembly swivels around the caster swivel axis.

16. The caster assembly of claim 13 further comprising:
a caster swivel joint coupled to the caster base;
a second primary wheel coupled to the caster base;
wherein the primary wheel and the second primary wheel rotate around substantially the same axis; and
wherein the primary wheel and the second primary wheel are substantially the same size.

17. The caster assembly of claim 13 further comprising:
a caster swivel joint coupled to the caster base; and
a second secondary wheel coupled to the caster base;
wherein the secondary wheel and the second secondary wheel rotate around substantially the same axis;
wherein the secondary wheel and the second secondary wheel are substantially the same size; and
wherein the secondary wheel is positioned on one side of the primary wheel and the second secondary wheel is positioned on the opposite side of the primary wheel.

18. The caster assembly of claim 13:
wherein a non-tread outer surface of the secondary wheel comprises a portion of a continuously curving surface.

19. The caster assembly of claim 13:
wherein the primary wheel and the secondary wheel are positioned in tandem.

20. A method of facilitating the rolling of a supported object over an obstacle threshold, comprising the act of:
positioning a secondary wheel of a caster assembly to contact the obstacle and lift a primary wheel of the caster assembly before the primary wheel of the caster assembly contacts the obstacle.

21. The method of claim 20 further comprising:
positioning the secondary wheel to remain within a sweep volume of the primary wheel as the caster assembly swivels around a caster swivel axis.
